(19) United States
(12) Patent Application Publication
(10) Pub. No.: US 2026/0034719 A1
(43) Pub. Date: Feb. 5, 2026

(54) CONTAINER TREATMENT SYSTEM COMPRISING A PRODUCTION MACHINE, A BLOW MOLDING MACHINE AND AT LEAST ONE HEAT EXCHANGE DEVICE

(71) Applicant: Krones AG, Neutraubling (DE)

(72) Inventor: Jochen HIRDINA, Regensburg (DE)

(21) Appl. No.: 19/280,024

(22) Filed: Jul. 24, 2025

(30) Foreign Application Priority Data
Aug. 2, 2024 (DE) 102024122108.9

(51) Int. Cl. B29C 49/78; B29C 49/42; B29C 49/64

(52) U.S. Cl. CPC B29C 49/786; B29C 49/4286; B29C 49/6465; B29C 2049/7878

(57) ABSTRACT

A container treatment system includes a production machine for preforms, a blow molding machine and at least one heat exchange device. The production machine and the blow molding machine are interlocked with one another, and the at least one heat exchange device is configured for heat exchange between the production machine and at least one component of the container treatment system.

### CROSS-REFERENCE TO RELATED APPLICATIONS

This application claims priority to, and the benefit of, German Patent Application No. 102024122108.9, filed Aug. 2, 2024, the contents of which are incorporated by reference herein in their entirety.

### TECHNICAL FIELD

The present invention relates to a container treatment system comprising a production machine for preforms, a blow molding machine, and at least one heat exchange device and to a method for producing containers in a container treatment system.

### BACKGROUND ART

Container treatment systems for treating containers are well known in

### THE PRIOR ART

In container treatment systems, large quantities of energy are typically released during the production of preforms and the treatment of containers. For sustainability and cost reasons, reuse of the released energy in the container treatment system is desirable.

### BRIEF SUMMARY

In general, aspects of the invention relate to a container treatment system and a method for producing containers by means of which containers can be produced in an energetically efficient manner.

In one embodiment, a container treatment system comprises a production machine for preforms, a blow molding machine and at least one heat exchange device. Another embodiment pertains to a method for producing containers in a container treatment system.

The container treatment system according to one embodiment of the invention comprises a production machine for preforms, a blow molding machine and at least one heat exchange device, wherein the production machine and the blow molding machine are interlocked with one another and the at least one heat exchange device is configured for heat exchange between the production machine and at least one component of the container treatment system.

A production machine can be understood to mean any machine suitable for producing preforms from a thermoplastic or other material. The production machine can, for example, be an injection molding machine. Alternatively, the production machine can also be a compression molding machine.

The blow molding machine can, for example, be a stretch blow molding machine configured to form preforms into containers with blown air, or a Liquiform machine. The Liquiform machine can be configured to form preforms into containers with a liquid. The liquid can be any liquid, such as water or a sterilizing liquid. It may be provided for the liquid to be removed from the container after molding. However, the liquid can also be a product with which the container is also ultimately to be filled. The product can therefore remain in the container even after molding, so that a separate filling step is not necessary. In this way, the container can be molded and filled at the same time.

The heat exchange device can be understood to mean any device which is configured to exchange a quantity of heat between the production machine and the at least one component of the container treatment system. An exchange can be understood, for example, to mean a direct or indirect heat exchange. Direct heat exchange can be understood, for example, to mean a direct supply of a process medium from the production machine to the at least one component of the container treatment system and/or a direct supply of a process medium from the one component of the container treatment system to the production machine. Indirect heat exchange can be understood, for example, to mean a heat exchange between a process medium of the production machine and a process medium of the at least one component. Indirect heat exchange can be achieved, for example, via a heat recovery device, such as a heat exchanger.

Hereinafter, a process medium shall be understood to mean a liquid or gaseous medium that can absorb and release heat. The process medium does not have to retain its state of aggregation, in particular when heat is supplied or dissipated, and can also undergo a change from the liquid to the gaseous state of aggregation or from the gaseous to the liquid. The process medium used can be, for example, air (hot air or cold air) and/or water and/or water vapor and/or supercritical water. Furthermore, within the meaning of the disclosure, several different process media can also be used, so that, for example, one or more gaseous process media and one or more liquid process media are used, which can circulate, for example, through the system or parts thereof (in particular the production machine and the component) in closed circuits.

Interlocking the production machine and the blow molding machine with one another can be understood to mean that operation of the production machine and operation of the blow molding machine are coordinated with one another and the two machines are connected directly and/or indirectly via a transport apparatus so that the preforms produced by the production machine can be transferred to the blow molding machine and blown by the latter to form containers. At least temporary, random intermediate storage of the preforms can also take place between the production machine and the blow molding machine. Alternatively, it can be provided for the preforms to be supplied from the production machine to the blow molding machine in a sorted manner, in particular without any unsorted intermediate storage of the preforms after leaving the production machine and before the preforms are supplied to the blow molding machine.

The at least one component of the container treatment system can be understood to mean any component of the container treatment system between which heat can be exchanged with the production machine. This may, for example, be a container treatment machine (such as the blow molding machine) of the container treatment system, a component part of a container treatment machine, a preform and/or container treated by a container treatment machine, or any other component of the container treatment system. Furthermore, the at least one component can also be a component of the production machine, so that, for example, heat can also be exchanged between two components of the production machine.

The containers may be bottles used in the beverage processing industry. Alternatively, they can also be any other type of container, such as a can or a syringe, which is suitable for holding a liquid and/or pasty medium. The container can also be a container used in the food industry, the medical industry or the cosmetics industry.

By means of the container treatment system according to an embodiment of the invention, heat can be exchanged between the production machine and/or the at least one component and thus, for example, a quantity of heat released at the production machine and/or the at least one component can be reused at another location in the container treatment system. Thus, the energy consumption of the container treatment system during container production can be reduced and energy-efficient operation of the container treatment system can be achieved.

In one embodiment, it can be provided for the production machine and the blow molding machine to be interlocked with one another via at least one transport apparatus for the mass transport of preforms and/or via at least one transport apparatus for the sorted transport of preforms. In this way, a type of preform transport can be flexibly selected based on the requirements of the downstream blow molding machine and a flexible container handling system can be provided.

It can further be provided for the heat exchange device to be configured for the direct exchange of a process medium between the production machine and the at least one component. In this way, the heat exchange device can be realized in a particularly simple manner and a quantity of energy contained in the process medium can be used directly by the production machine and/or the at least one component, whereby the energy consumption of the entire container treatment system can be reduced.

In one embodiment, the process medium can comprise a cooling medium of the production machine and the heat exchange device can be configured to supply the cooling medium to the at least one component for cooling or heating a component part of the component and/or for cooling or heating a preform and/or container treated by means of the component. The component part can be understood to mean a subcomponent of the component. The component part can, for example, be used to carry out a treatment step on the preform and/or container. However, the component part can also be indirectly involved in a treatment step on the preform and/or container. However, it may also be a component part that is neither directly nor indirectly involved in the treatment of the preform and/or container. For example, if the component is the blow molding machine, the component part can be a blow mold, a heating apparatus or any other component part of the blow molding machine. In this way, the cooling medium used by the production machine can be used flexibly to cool or heat component parts and preforms and/or containers, further reducing the energy consumption of the container treatment system.

In one embodiment, the at least one component can comprise a tempering apparatus for preforms and/or a tempering apparatus for containers. Tempering apparatuses are characterized by particularly high energy consumption and typically generate large quantities of heat, so that the energy consumption of the container treatment system can be significantly reduced by a heat exchange between the production machine and the respective tempering apparatus.

Furthermore, it can be provided for the heat exchange device to be configured to supply a quantity of heat released in the production machine to the tempering apparatus for preforms and/or to the tempering apparatus for containers for tempering a component part of the respective tempering apparatus and/or for tempering the preforms and/or containers. Thus, the exchanged heat quantity in the tempering apparatus can be reused in a flexible manner and the energy required by the container treatment system can be further reduced.

In one development of one of the two previous embodiments, the heat exchange device can be configured to supply a quantity of heat released in the tempering apparatus for preforms and/or in the tempering apparatus for containers to the production machine. Since large quantities of heat are typically released in the tempering apparatus, the energy required by the container treatment system can be significantly reduced by reusing the quantity of heat released in the tempering apparatus.

In one development of the previous embodiment, the heat exchange device can be configured to supply the quantity of heat released in the tempering apparatus for containers and/or the tempering apparatus for containers to the production machine for tempering a component part and/or for tempering a material for producing preforms. Thus, the quantity of heat exchanged in the production machine can be used flexibly for various processes.

What is furthermore provided according to aspects of the invention is a method for producing containers in a container treatment system, wherein the container treatment system comprises a production machine for preforms, a blow molding machine and at least one heat exchange device. The method comprises operating the container treatment system with the production machine and the blow molding machine interlocked with one another. During operation, the at least one heat exchange device is configured for heat exchange between the production machine and at least one component of the container treatment system.

By means of the method according to the invention, heat can be exchanged between the production machine and/or the at least one component and thus, for example, a quantity of heat released at the production machine and/or the at least one component can be reused at another location in the container treatment system. In this way, the energy consumption of the container treatment system during container production is reduced and energy-efficient operation of the container treatment system is made possible.

In one embodiment of the method, the production machine and the blow molding machine can be interlocked with one another via at least one transport apparatus for the mass transport of preforms and/or via at least one transport apparatus for the sorted transport of preforms. In this way, a type of preform transport can be flexibly selected based on the requirements of the downstream blow molding machine.

Furthermore, it can be provided for a process medium to be exchanged directly between the production machine and the at least one component by means of the heat exchange device. Thus, the heat exchange device can be realized in a particularly simple manner and a quantity of energy contained in the process medium can be used by the at least one component, whereby the energy consumption of the entire container treatment system can be reduced.

In one development of the previous embodiment, it can be provided for the process medium to comprise a cooling medium of the production machine and for the cooling medium to be supplied to the at least one component by means of the heat exchange device for cooling a component part of the component and/or a preform and/or container treated by means of the component. In this way, the cooling medium used by the production machine can be used in a particularly flexible manner to cool component parts and preforms and/or containers, further reducing the energy consumption of the container treatment system.

In one embodiment of the method, the at least one component can comprise a tempering apparatus for preforms and/or a tempering apparatus for containers. Tempering apparatuses are characterized by particularly high energy consumption and typically generate large quantities of heat, so that the energy consumption of the container treatment system can be significantly reduced by a heat exchange between the production machine and the respective tempering apparatus.

In one development of the previous embodiment, it can be provided for a quantity of heat released in the production machine to be supplied to the tempering apparatus for preforms and/or to the tempering apparatus for containers by means of the heat exchange device for tempering a component part of the respective tempering apparatus and/or for tempering the preforms and/or containers. Thus, the quantity of heat exchanged in the tempering apparatus can be used flexibly for various processes.

In one development of one of the two previous embodiments, it can be provided for a quantity of heat released in the tempering apparatus for preforms and/or in the tempering apparatus for containers to be supplied to the production machine by means of the heat exchange device, in particular for tempering a component part and/or for tempering a material for producing preforms. Since large quantities of heat are typically released in the tempering apparatus, the energy required by the container treatment system can be significantly reduced by reusing the quantity of heat released in the tempering apparatus. Furthermore, the quantity of heat exchanged in the production machine can be used flexibly.

### BRIEF DESCRIPTION OF THE DRAWING FIGURE

FIG. 1 is a schematic diagram of a container treatment system comprising a production machine, a blow molding machine and at least one heat exchange device, according to one embodiment.

### DETAILED DESCRIPTION

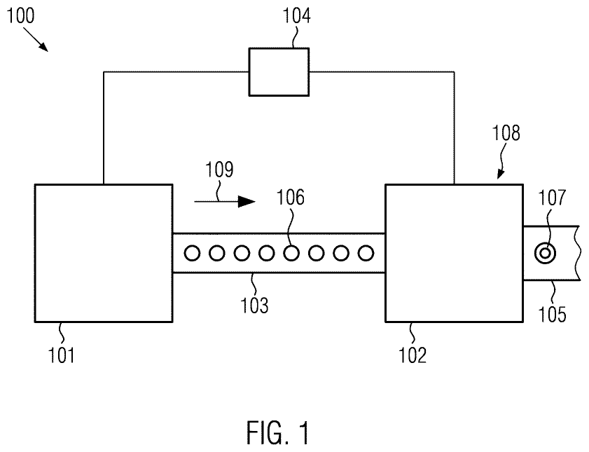

FIG. 1 shows a container treatment system 100 comprising a production machine 101, a blow molding machine 102 and at least one heat exchange device 104, according to one embodiment. According to an embodiment of the invention, the production machine 101 and the blow molding machine 102 are interlocked with one another and the heat exchange device 104 is configured for heat exchange between the production machine 101 and at least one component 108 of the container treatment system 100.

Furthermore, the container treatment system 100 can comprise a transport apparatus 103 for transporting preforms 106 between the production machine 101 and the blow molding machine 102, as well as a transport apparatus 105 for transporting containers 107 from the blow molding machine 102 to another optional container treatment machine (not explicitly shown herein) of the container treatment system 100.

The configuration of the container treatment system 100 described in connection with FIG. 1 is to be understood as exemplary.

Thus, in addition to the production machine 101, the blow molding machine 102 and at least one heat exchange device 104 according to the invention and the optional transport apparatuses 103, 105, the container treatment system 100 can comprise further components not explicitly shown herein. For example, further container treatment machines, such as a filler, a labeler, a closer, a pasteurizer, further transport apparatuses and/or other components not explicitly mentioned herein may be provided.

In the embodiment shown herein, the at least one component 108 is the blow molding machine 102. This specific configuration of the at least one component 108 is to be understood as exemplary. Thus, the at least one component 108 can also be any other component of the container treatment system 100.

In general, the at least one component 108 can be a container treatment machine of the container treatment system 100, a component part of a container treatment machine (such as a blow mold), a preform and/or container treated by a container treatment machine, or any other component 108 between which heat can be exchanged with the production machine 101 via the heat exchange device 104.

The production machine 101 can be any machine suitable for producing preforms using a thermoplastic material. For example, the production machine 101 can be configured as an injection molding machine or a compression molding machine. The exemplary configurations just mentioned are not to be understood as limiting, so that the production machine 101 can also be configured in any other suitable manner.

The blow molding machine 102 can be any machine suitable for molding preforms to form containers. For example, the blow molding machine can be configured as a stretch blow molding machine or extrusion blow molding machine. The blow molding machine can, for example, comprise a carousel with a plurality of blow molds in which the preforms can be blown into containers. The configuration of the blow molding machine 102 just described is not to be understood as limiting, which means that any other suitable configuration of the blow molding machine is also conceivable. For example, the blow molding machine can also be configured as a linear blow molding machine.

In the embodiment of FIG. 1, the blow molding machine 102 is arranged downstream of the production machine 101 with respect to a transport direction 109 of the preforms 106.

In embodiments of the invention, the production machine 101 and the blow molding machine 102 are interlocked with one another. This can be understood to mean that operation of the production machine 101 and of the blow molding machine 102 are coordinated with one another and the two machines are connected directly and/or indirectly via a transport apparatus 103 so that the preforms 106 produced by the production machine 101 can be transferred to the blow molding machine 102 and blown by the latter to form containers 107. The transport of the preforms with the transport apparatus 103 can preferably be carried out in a sorted manner and without (unsorted) intermediate storage of the preforms, so that preforms leaving the production machine are supplied directly and always in the same way (in particular with approximately the same temperature of the preforms) to the blow molding machine.

Operation of the production machine 101 and of the blow molding machine 102, as well as of any other component of the container treatment system 100, can be controlled via a control unit (such as a computer with a processor and associated memory and program code stored in an executable manner in the memory). For example, operation of the production machine 101 and of the blow molding machine 102 can be coordinated via the control unit.

In the embodiment discussed herein, the production machine 101 and the blow molding machine 102 are interlocked with one another via the linear transport apparatus 103, wherein the preforms 106 are transferred in a sorted manner from the production machine 101 to the blow molding machine 102 by means of the transport apparatus 103. In the blow molding machine 102, the preforms 106 can then be blown to form containers 107 and, by means of the optional transport apparatus 105, supplied to further components of the container treatment system 100, which are optionally arranged downstream of the blow molding machine 102.

The type of interlocking of the production machine 101 and blow molding machine 102 via the linear transport apparatus 103 for the sorted transport of preforms 106, as described in FIG. 1, is to be understood as exemplary. For example, it can also be provided for the transport apparatus 103 to be configured as at least one or more rotating stars, by means of which the preforms can be transferred in a sorted manner from the production machine 101 to the blow molding machine 102.

Alternatively, the transport apparatus 103 can also be configured, for example, as a transport apparatus for the mass transport of preforms.

Furthermore, it can also be provided for the preforms 106 to be transferred from the production machine 101 to the blow molding machine 102 by means of a combination of at least one transport apparatus configured for mass transport and at least one transport apparatus configured for sorted transport. The two transport apparatuses can be connected to one another, for example, via a preform separating apparatus, by means of which the preforms 106 can be transferred in a sorted manner to the transport apparatus configured for sorted transport.

Furthermore, it can also be provided, for example, for the preforms 106 to be guided from the production machine 101 into an optional storage device by means of a first transport apparatus and to be supplied from the optional storage device to the blow molding machine 102 by means of a second transport apparatus. In this case, it can be provided, for example, for the preforms to be supplied to the optional storage device by means of the first transport apparatus in an unsorted mass transport and to be supplied from the storage device to the blow molding machine 102 by means of the second transport apparatus in a sorted manner.

According to embodiments of the invention, as already described above, the container treatment system 100 comprises at least one heat exchange device 104. The at least one heat exchange device 104 can be any device suitable for exchanging heat between the production machine 101 and the at least one component 108.

The heat exchange can be direct and/or indirect heat exchange.

Direct heat exchange means that a process medium can be directly exchanged between the production machine 101 and the at least one component 108, which in the embodiment of FIG. 1 is the blow molding machine 102. This means that the process medium of the production machine 101 is supplied directly to the at least one component 108 or the process medium is supplied from the at least one component 108 directly to the production machine 101.

In this case, it can be provided, for example, for a process medium to be supplied to the production machine 101, to the at least one component 108 for heating or cooling the at least one component 108 and/or for heating or cooling a preform and/or container treated by at least one component 108. Furthermore, it can be provided for the process medium, after having been used for heating or cooling in the at least one component 108, to be returned to the production machine 101 via a further line. For example, a circuit can be provided for circulating the process medium between the production machine 101 and the at least one component 108. In the production machine 101, heat can then be absorbed by the process medium, which can then be dissipated to the component, or vice versa. In this case, the process medium serves to cool or heat the production machine or a part thereof (such as an injection molding tool of an injection molding machine as an embodiment of a production machine) and further to heat or cool the component, wherein the heat exchange is effected by the transfer of heat from the production machine to the component (or vice versa) through the process medium.

Furthermore, it can also be provided conversely for a process medium of the at least one component 108 to be supplied to the production machine 101 for heating or cooling a component part, a production material and/or a preform produced by the production machine 101.

Indirect heat exchange is, in turn, to be understood as meaning that heat is exchanged between a first process medium of the production machine 101 and a second process medium of the at least one component 108 indirectly via a heat recovery device, such as a heat exchanger. In this case, it can be provided, for example, for the first process medium to be circulated through a first line and the second process medium through a second line and for the two lines to be at least partially in thermal contact with one another (for example in the heat exchanger) so that heat can be exchanged between the two process media.

The embodiment described in FIG. 1, in which the heat exchange device 104 is configured for heat exchange between the production machine 101 and the blow molding machine 102, is to be understood as exemplary.

The heat exchange device 104 can generally also be configured for heat exchange between the production machine 101 and any other component 108 of the container treatment system 100. Furthermore, the container treatment system 100 can also comprise more than one heat exchange device 104. For example, it can be provided for a heat exchange device 104, as shown in FIG. 1, to be provided for heat exchange between the production machine 101 and the blow molding machine 102 and at least one further heat exchange apparatus 104 to be provided for heat exchange between the production machine 101 and at least one further component of the container treatment system 100, such as an optional pasteurizer. Furthermore, the heat exchange device does not necessarily have to be configured for heat exchange between the production machine 101 and the blow molding machine 102, as shown in FIG. 1, but can also be configured, for example, only for heat exchange between the production machine 101 and at least one component of the container treatment system 100, which is different from the blow molding machine 102.

As already described above, the exchange of a process medium between the production machine 101 and the at least one component 108, which in the embodiment of FIG. 1 is the blow molding machine 102, can be provided for heat exchange.

A plurality of process media can be used in the production machine 101, which are used to heat or cool component parts of the production machine 101, production material for preforms and/or preforms produced by the production machine.

Furthermore, it can also be provided to heat component parts of the production machine using heating apparatuses.

Both the quantity of heat contained in the process media of the production machine and the quantity of heat emitted by the heated component parts of the production machine can be exchanged with the at least one component 108 of the container treatment system 100 by means of the heat exchange apparatus 104. Furthermore, a process medium used for cooling can also be exchanged with the at least one component 108 by the heat exchange device, and the amount of energy originally supplied to the cooling medium for cooling can also be used at another location in the container treatment system 100. In this way, the energy consumption of the entire container treatment system 100 can be reduced.

The process medium of the production machine 101 can be, for example, a cooling medium by means of which component parts of the production machine 101 can be cooled. The cooling medium can be provided, for example, for cooling a molding apparatus of the production machine 100. In the case of an injection molding machine, this can be, for example, an injector used for preform injection molding, or a mold, in particular a molding tool for molding the preforms. However, the process medium can also be, for example, hot air, by means of which the production material can be heated before it is supplied to the molding apparatus of the production machine 101, for example to an injector of the injection molding machine. Furthermore, the process medium can also be cooling air, which can be used in a cooling region of the production machine to cool the finished preforms.

By exchanging a process medium of the production machine 101 with the at least one component 108 via the heat exchange device 104, heat quantities released in the production machine 101 or energy quantities used to heat or cool a process medium can be reused at another location in the container treatment machine. Accordingly, it can also be provided for a process medium of the at least one component 108 of the container treatment system 100 to be supplied via the heat exchange device 104 of the production machine 101 and used in the production machine 101 for cooling or heating a component part, a production material for preforms and/or the finished preforms.

In this way, the energy required by the entire container treatment system can be reduced, thereby achieving more sustainable and cost-efficient operation of the container treatment system.

If the blow molding machine 102 shown in FIG. 1 comprises, for example, a tempering apparatus for preforms and/or a tempering apparatus for containers, a heat exchange between the tempering apparatus for preforms and/or containers and the production machine 101 can be carried out, for example, by means of the heat exchange device 104.

In this case, it can be provided, for example, for a quantity of heat released in the production machine 101 to be supplied to the tempering apparatus for heating a component part and/or for heating a preform and/or container. The quantity of heat released in the production machine 101 can, for example, be a quantity of heat released by the production apparatus (such as a tool for forming the preforms) of the production machine 101 during production of the preforms. If the production machine 101 is configured as an injection molding machine, the production apparatus can also be an injector by means of which a heated preform starting material is introduced into the tool of the injection molding machine. The quantity of heat can, for example, be the quantity of heat released in the production machine when the preform production material is heated. The quantity of heat can also be any other quantity of heat not explicitly mentioned herein that is released in the production machine. As described above, the released quantity of heat can be exchanged between the production machine 101 and the tempering apparatus via a process medium, such as air or a liquid.

Alternatively, it can also be provided, for example, for a quantity of heat released in the tempering apparatus to be supplied to the production machine 101 via the heat exchange device 104. The quantity of heat released in the tempering apparatus can, for example, be supplied to the production machine to heat the material for producing the preforms. Furthermore, it can also be provided for the quantity of heat released in the tempering apparatus to be supplied to the molding apparatus of the production machine. As already described above, the heat exchange can be realized using a process medium, such as air or a liquid.

The examples just mentioned are not to be understood as limiting, so that the quantity of heat from the tempering apparatus can also be supplied to any other part of the production machine 101 and the quantity of heat from the production machine 101 can be supplied to any part of the tempering apparatus.

Furthermore, it can also be provided to exchange a process medium, which is used for cooling in the production machine 101, between the production machine 101 and the tempering apparatus for cooling the tempering apparatus or a container treated by means of the tempering apparatus. As described above, the process medium can, for example, be a cooling medium of the production machine 101, which is used to cool the molding apparatus of the production machine, such as the injector of an injection molding machine. For example, it can be provided for the cooling medium of the production machine to be supplied to the tempering apparatus for cooling a bottom of a container.

Additionally or alternatively, it can also be provided for a cooling medium to be supplied to the tempering apparatus of the production machine 101 via the heat exchange device 104 and used in the production machine, for example, for cooling a component part and/or preforms produced by means of the production machine 101. The cooling medium can be, for example, cooling air or a cooling liquid.

The statements made above with regard to the tempering apparatus also apply mutatis mutandis to any other component of the blow molding machine 102 or any other component of the container treatment system 100.

What is claimed is:

1. A container treatment system comprising
a production machine for preforms,
a blow molding machine, and
at least one heat exchange device;
wherein the production machine and the blow molding machine are interlocked with one another; and
wherein the at least one heat exchange device is configured for heat exchange between the production machine and at least one component of the container treatment system.

2. The container treatment system according to claim 1, wherein the production machine and the blow molding machine are interlocked with one another via at least one transport apparatus for the mass transport of preforms and/or via at least one transport apparatus for the sorted transport of preforms.

3. The container treatment system according to claim 1, wherein the heat exchange device is configured for the direct exchange of a process medium between the production machine and the at least one component.

4. The container treatment system according to claim 3, wherein the process medium comprises a cooling medium of the production machine and the heat exchange device is configured to supply the cooling medium to the at least one component for cooling a component part of the component and/or for cooling a preform and/or container treated by means of the component.

5. The container treatment system according to claim 1, wherein the at least one component comprises a tempering apparatus for preforms and/or a tempering apparatus for containers.

6. The container treatment system according to claim 5, wherein the heat exchange device is configured to supply a quantity of heat released in the production machine to the tempering apparatus for preforms and/or to the tempering apparatus for containers for tempering a component part of the respective tempering apparatus and/or for tempering the preforms and/or containers.

7. The container treatment system according to claim 5, wherein the heat exchange device is configured to supply a quantity of heat released in the tempering apparatus for preforms and/or in the tempering apparatus for containers to the production machine.

8. The container treatment system according to claim 7, wherein the heat exchange device is configured to supply the quantity of heat released in the tempering apparatus for containers and/or the tempering apparatus for containers to the production machine for tempering a component part and/or for tempering a material for producing preforms.

9. A method for producing containers in a container treatment system, wherein the container treatment system includes a production machine for preforms, a blow molding machine and at least one heat exchange device, the method comprising:
operating the container treatment system with the production machine and the blow molding machine interlocked with one another;
wherein the at least one heat exchange device is configured for heat exchange between the production machine and at least one component of the container treatment system.

10. The method according to claim 9, wherein the production machine and the blow molding machine are interlocked with one another via at least one transport apparatus for the mass transport of preforms and/or via at least one transport apparatus for the sorted transport of preforms.

11. The method according to claim 9, wherein a process medium is exchanged directly between the production machine and the at least one component by means of the heat exchange device.

12. The method according to claim 11, wherein the process medium comprises a cooling medium of the production machine and the cooling medium is supplied to the at least one component by means of the heat exchange device for cooling a component part of the component and/or a preform and/or container treated by means of the component.

13. The method according to claim 9, wherein the at least one component comprises a tempering apparatus for preforms and/or a tempering apparatus for containers.

14. The method according to claim 13, wherein a quantity of heat released in the production machine is supplied to the tempering apparatus for preforms and/or to the tempering apparatus for containers by means of the heat exchange device for tempering a component part of the respective tempering apparatus and/or for tempering the preforms and/or containers.

15. The method according to claim 13, wherein a quantity of heat released in the tempering apparatus for preforms and/or in the tempering apparatus for containers is supplied to the production machine by means of the heat exchange device, in particular for tempering a component part and/or for tempering a material for producing preforms.
